(19) United States
(12) Patent Application Publication
(10) Pub. No.: US 2005/0206034 A1
(43) Pub. Date: Sep. 22, 2005

(54) Transfer mold, production method thereof and production method of fine structure

(76) Inventors: Chikafumi Yokoyama, Zama-shi (JP); Akira Yoda, Tokyo (JP); Hiroshi Kikuchi, Yamato-shi (JP)

Correspondence Address: 3M INNOVATIVE PROPERTIES COMPANY, PO BOX 33427, ST. PAUL, MN, 55133-3427, US

(21) Appl. No.: 11/030,261

(22) Filed: Jan. 6, 2005

(30) Foreign Application Priority Data
Jan. 6, 2004 (JP) 2004-001108

(51) Int. Cl. B29C 33/40; B29C 35/08

(52) U.S. Cl. 264/219; 264/496; 249/134

(57) ABSTRACT

To provide a transfer mold that is useful for producing a fine structure having a surface area and a complicated rib shape such as a grid-like rib, can be easily peeled from a master mold used as a matrix and can form a protrusion pattern, particularly a grid-like protrusion pattern, free from defects such as breakage, destruction and deformation while keeping high dimensional accuracy of the matrix.

### BACKGROUND

A plasma display panels (PDP) have drawn an increasing attention in recent years as a flat panel display that is thin and has a large screen. Such panels are being used for business purposes and as wall-hung television sets.

A plasma display panel (PDP) generally contains a large number of fine discharge display cells. Each discharge display cell is encompassed and defined by a pair of glass substrates spaced apart from each other with barrier partitions (also called “barrier ribs”) between the glass substrates. The barrier ribs are generally composed of a fine structure of ceramic material. When a single set of parallel barrier ribs are employed, the barrier ribs form a striped pattern. In such embodiment, the discharge display cells are the trough depressions between the barrier ribs. Alternatively, the barrier partitions may have a grid pattern.

Several methods of forming a barrier ribs are known. See for example JP 9-283017 and JP 10-134705.

### BRIEF DESCRIPTION OF THE DRAWINGS

FIG. 1 is a sectional view showing an example of a PDP.

FIG. 2 is a perspective view showing a PDP back plate used in the PDP shown in FIG. 1.

FIG. 3 is a perspective view showing a transfer mold according to the invention.

FIG. 4 is a sectional view of the mold taken along a line IV-IV in FIG. 3.

FIG. 5A-5C is a sectional view showing, in sequence, a production method of a transfer mold according to the invention.

FIG. 6 is a perspective view of a master mold used as a matrix in the production method shown in FIG. 5.

FIG. 7 is a flowchart showing a basic concept of a production method of a fine structure according to the invention.

FIG. 8A-8C is a sectional view showing, in sequence, a production method of a flexible mold used as a second transfer mold in a production of a fine structure by using the transfer mold of the invention as a first transfer mold.

FIG. 9 is a sectional view showing, in sequence, a production method of a fine structure by using the flexible mold produced by the method shown in FIG. 8.

### SUMMARY OF THE INVENTION

When a the silicone sheet is heat pressed during the production process of the mold, as described in JP 10-134705, dimensional changes occur. Accordingly, industry would find advantages in molds and methods of making such molds having improved dimensional accuracy.

In one aspect the invention relates to a transfer mold comprising a transfer pattern layer having a positive protrusion pattern surface comprised of a polymeric material, supported by a base layer comprised of a different material than the transfer pattern layer.

In another aspect, the invention relates to a method of producing a transfer mold comprising providing a base substrate, forming a transfer pattern layer having a positive protrusion pattern from a curable polymeric composition wherein the curable composition comprises a different material than the base substrate, and curing the transfer pattern layer is preferably cured at ambient temperature. The transfer pattern layer is preferably formed from a master mold having on a surface thereof a negative groove pattern such as by applying the curable composition onto the negative groove pattern surface of the master mold and stacking the base substrate onto the master mold.

In other aspect invention also relates to methods of producing positive and negative replications of the transfer mold as well as methods of producing a fine structure (e.g. plasma barrier ribs) from a molded replica of the transfer mold.

Each of these aspects may include any one or combination of various features such as described as follows. The base preferably comprises a material having a Young's modulus ranging from 1 GPa to 250 GPa and more preferably from 100 GPa to 250 GPa. Metal materials such as stainless steel, copper and alloys thereof are preferred base material. The transfer pattern layer typically has a thickness ranging from 0.005 mm to 10 mm; whereas the thickness of the base ranges from 0.1 mm to 5 mm. The protrusion pattern of the transfer pattern layer may comprise a pattern suitable for a plasma display panel such as a parallel rib pattern or grid pattern. The transfer pattern layer preferably comprises a composition curable at ambient temperature such as silicone rubber and (e.g. polyester) polyurethane. A primer layer may be disposed between the base layer and the transfer pattern layer.

### DETAILED DESCRIPTION OF PREFERRED EMBODIMENTS

The invention relates to a transfer mold, its production method and a production method of a fine structure. In the description that follows, embodiments of the invention will be explained in detail with respect to the production of a PDP rib as a typical example of the fine structure. The invention is surmised useful for other structures and thus is not limited to the production of the PDP rib.

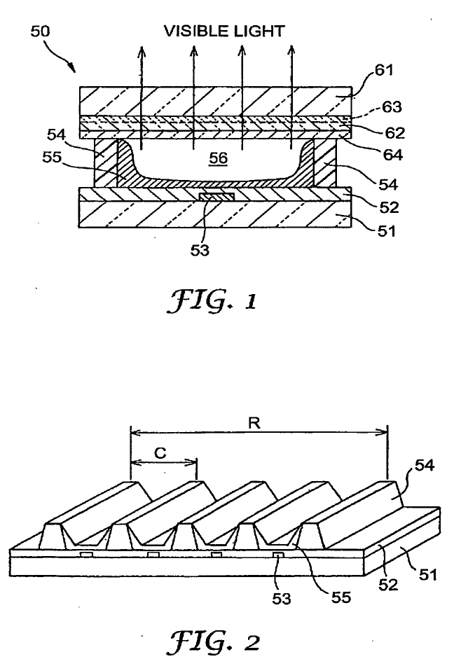

With reference to FIG. 1 and FIG. 2, each discharge display cell 56 is encompassed and defined by a pair of glass substrate opposing each other with a spacing between them, that is, a front glass substrate 61 and a back glass substrate 51, and fine structure ribs (barrier ribs; also called “partitions” or “barriers”) 54. The front glass substrate 61 has thereon transparent electrodes 63 consisting of scanning electrodes and sustaining electrodes, a transparent dielectric layer 62 and a transparent protective layer 64. The back glass substrate 51 has thereon address electrodes 53 and a dielectric layer 52. The display electrode 63 having the scanning electrode and the sustaining electrode and the address electrode 53 intersect each other and are arranged in a predetermined spacing, respectively. Each discharge display cell 56 has a phosphor layer 55 on its inner wall and contains a rare gas (such as Ne—Xe gas) sealed therein so that self-emission light display can be made due to plasma discharge between the electrodes.

The ribs 54 of the PDP are arranged on the back surface glass substrate 51 and constitute the back surface plate for the PDP. The gap of the ribs 54 (cell pitch) C varies with a screen size but is generally at least about 150 and typically no greater than about 400 μm.

Generally, the ribs satisfy two criteria, that is, “they are free from defects such as mixture of bubbles and deformation” and “they have high pitch accuracy”. As to pitch accuracy, the ribs are arranged at predetermined positions during molding with minimal positioning errors to address electrodes. The positioning error is no greater than one third of the average pitch. The positioning error is typically less than 25% of the average pitch, preferably less than 20% of the average pitch, more preferably less than 15%, and even more preferably less than 10% of the average pitch.

As the screen size has becomes larger, pitch accuracy of the ribs become increasingly important. When the ribs 54 are taken into consideration as a whole, the total pitch R of the ribs 54 (distance between ribs 54 at both ends; though the drawing shows only five ribs, about 3,000 ribs exist generally) typically have a dimensional accuracy within 10 μm to 30 μm.

It is generally advantageous to mold the ribs by use of a flexible mold including a support and a shape-imparting layer with a groove pattern supported by the support. In the case of such a molding method, the desired dimensional accuracy can be achieved.

The transfer mold according to the invention is particularly advantageous for forming grid-like ribs for the PDP for the following reasons.

The number of discharge display cells is as great as two to three millions in the case of a large-sized PDP of the 42-inch class. Therefore, an extremely long period of time is necessary for a machining process of the mold. In the case of a grid-like rib having 3,000 longitudinal ribs and 1,000 transverse ribs, for example, 3,000,000 (3,000×1,000) discharge cells are bored to fabricate a master mold having a grid-like protrusion pattern. Instead, when a design is so changed as to process the grid-like groove pattern to the master mold according to the invention, only 4,000 (3,000+1,000) grooves need be linearly cut and formed. In other words, the invention can reduce the machining time of the master mold and thereby the cost. By use of a transfer mold as the mold for producing the fine structure, the invention eliminates the necessity for producing a large number of master molds.

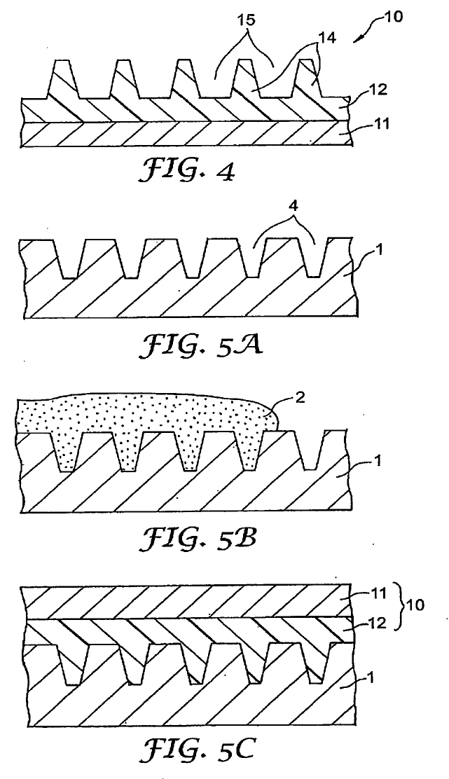

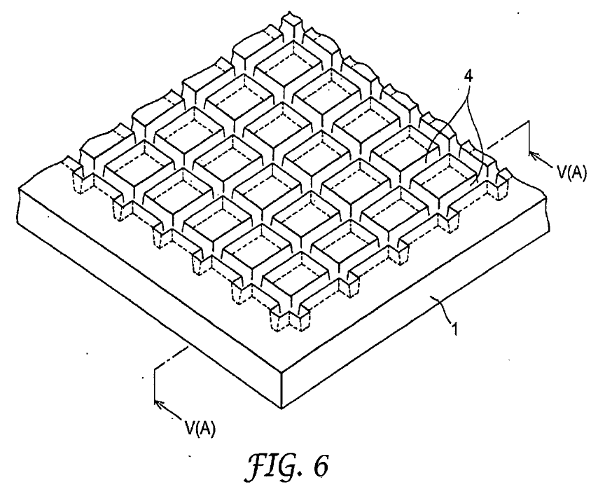

For the sake of explanation, the term “grid-like pattern” used for explaining the grid-like ribs means not only the typical grid-like pattern that will be hereinafter explained with reference to FIGS. 4 and 6 but also similar pattern having a structure approximate to the grid. Examples of the patterns effective for executing the invention include a meander pattern, a waffle pattern, a diamond pattern, and so forth.

As will be hereinafter explained in detail, the illustrated PDP ribs can be produced advantageously by the steps of forming a transfer mold by use of a master mold having a shape and a size corresponding to those of the rib as a mold, duplicating a flexible mold from the transfer mold, that is, by forming the flexible mold by using the transfer mold as a substantial matrix. When the flexible mold is used, the intended PDP ribs can be produced easily and highly accurately.

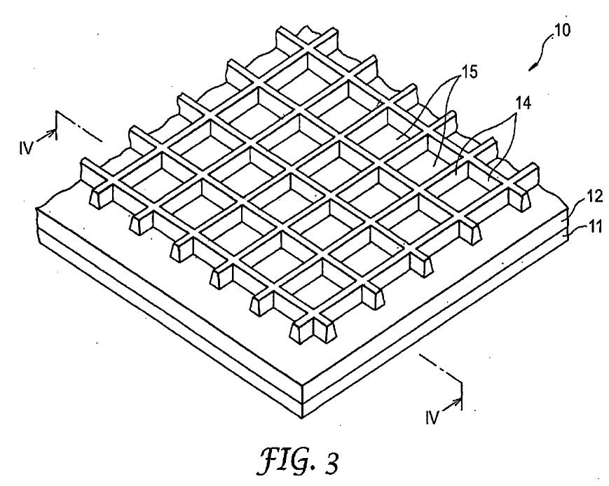

First, the invention resides in a mold for transfer (hereinafter merely called “transfer mold”) that is used for transferring a fine structure pattern in the production of a fine structure. FIG. 3 is a perspective view showing a preferred form of the transfer mold according to the invention and FIG. 4 is a sectional view taken along a line IV-IV of FIG. 3. As shown in these drawings, the transfer mold 10 includes a base 11 and a transfer pattern layer 12 supported on the back thereof by the base 11 and having on the surface thereof a positive protrusion pattern 14 having a shape and a size corresponding to those of the fine structure pattern (grid-like pattern in the drawings).

The transfer mold 10 according to the invention has a transfer pattern layer 12 is formed of a cured two-component composition. The transfer pattern layer is preferably formed from a room temperature curable composition such as a silicone rubber or polyurethane.

The fine structure produced by use of the transfer mold shown in the drawings is not particularly limited. A preferred fine structure pattern in the practice of the invention is the fine structure pattern for the PDP ribs as described above. The positive protrusion pattern of the transfer mold is generally a straight pattern constituted by a plurality of protrusion portions arranged substantially parallel to one another with predetermined gaps among them, or a grid-like pattern 14 constituted by a plurality of protrusion patterns arranged substantially parallel to one another while intersecting one another with predetermined gaps among them as shown in FIG. 3. The grid-like patterns 14 adjacent to one another define a cavity 15 corresponding to a discharge display cell of the PDP panel, for example. Even when the fine structure pattern has a complicated pattern typified by the grid-like pattern, the transfer mold according to the invention typically exhibits a relatively low peeling force when the transfer mold is peeled from the master mold. The transfer mold according to the invention exhibits less breakage of the protrusion portions.

In the transfer mold described herein, the base is preferably comprised of a different material that the transfer layer. The base is preferably formed of a hard material having a Young's modulus of at least 1 GPa and typically no greater than 300 GPa. The Young's modulus (i.e. modulus of longitudinal elasticity) of various materials is known and is described in the literature such as in the JSME Mechanical Engineers' Handbook, Japan Society of Mechanical Engineers, 1984. Preferably, the base has a Young's modulus of at least about 100 GPa and typically no greater than about 220 GPa Such a hard material is preferred for maintaining the high dimensional accuracy of the master mold when the mold for use in transfer (transfer mold) is produced from the master mold. In other words, when a molding material of the transfer pattern layer is applied to and cured on the master mold, it is generally difficult to precisely keep dimensional accuracy of the resulting transfer pattern because the molding material of the transfer pattern layer undergoes shrinkage upon curing. When a hard material having a high elastic modulus is employed for the base, the invention can provide high dimensional accuracy.

The hard material suitable for the base includes a broad range of metals and plastic materials. Metal materials are particularly useful. Examples of the suitable metal materials include stainless steel (e.g. Young's modulus of about 200 Gpa), copper (e.g. Young's modulus of about 130 GPa), and brass (e.g. Young's modulus of about 100 GPa). The metal materials may be used either individually or in the form of an alloy, whenever desired. Plastic materials having the desired young's modulus include for example nylon (e.g. Young's modulus ranging from about 1.2 to 2.9 GPa), polystyrene (e.g. Young's modulus of about 2.7 to about 4.2 GPa), and certain polyethylene materials.

The base is generally used in the form of a sheet or plate made of a single hard material but may be used in the form of a composite or laminate (stacked body), whenever desired. The thickness of the base can be changed in a broad range depending on the specification of the transfer mold but is generally within the range of about 0.1 to 5 mm and more preferably within the range of about 0.5 to 3 mm. When the thickness of the base is smaller than 0.1 mm, handling property of the transfer mold drops and it becomes difficult to maintain the high dimensional accuracy of the mold. When a PET film is used as the base in place of a metal plate having a predetermined thickness, for example, the transfer mold becomes light in weight but it becomes difficult to keep high dimensional accuracy any more. When the thickness of the transfer mold exceeds 5 mm, on the contrary, the handling property of the transfer mold drops because the weight increases.

The transfer pattern layer, a back surface of which is supported by the base, is formed of a curable composition that is preferably curable at room temperature. In at least some embodiments, the curable composition is preferably a (e.g. two-component) silicon rubber or polyurethane. When the transfer pattern layer is formed from a room temperature curable composition, the substrate and the master mold need not be heat-treated unlike thermosetting resins. Therefore, deformation resulting from heating and the drop of dimensional accuracy resulting from this deformation can be avoided. It is also surmised to form the transfer pattern layer by use of a photo-curable resin and a moisture-curable resin. However, it is appreciated that it is more difficult to sufficiently cure such compositions while the resin is sandwiched between the master mold and the substrate.

The transfer pattern layer composition preferably has low surface energy and flexibility. Consequently, the peeling force of removing the transfer mold (first transfer mold) from the master mold as well as the peeling work of removing the transfer mold after molding the fine structure (second transfer mold from the first transfer mold) is relatively low. In at least some preferred embodiments, the 180° peel force after conditioning for 24 hours of removal is less than 5 kgf/100 mm and more preferably less than 1 kgf/100 mm (e.g. less than 0.5 kgf/100 mm.

The (e.g. room temperature) curable transfer pattern layer composition can generally be cured within a few hours. Therefore, the transfer mold can be produced in a few hours. Because the transfer pattern layer has the strength capable of withstanding the repetition of use, the transfer mold thus produced can be used (e.g. as a substantial matrix) in place of the conventional master mold. This reduces processing time in comparison to producing the mold by direct machining.

The room temperature-curable silicone rubbers can be cured at ambient temperature (about 20 to 25° C.), and are generally classified into one-component type products curable upon reacting with the moisture in air and two-component type products in which a main component and a curing agent are mixed in a predetermined ratio at the time of use and which can be cured upon reaction therebetween. Various curable silicone rubber compositions can be employed so long as it can form a desired transfer pattern layer. In one embodiment, the room temperature-curable silicone rubber comprises at least one (e.g. difunctional) organopolysiloxane, a cross linking agent and a catalyst.

The organopolysiloxane can be represented by the following formula (I): 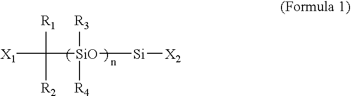
wherein R₁ to R₄ are each independently hydrogen atom or an organic group, preferably a substituted or unsubstituted alkyl group such as a methyl group or an ethyl group;
X₁ and X₂ are each independently a reactive group, preferably a functional group such as a hydroxyl group; and
n is an integer of about 100 to 1,000.

The cross linking agent is preferably a silane or polysiloxane having at least two functional groups such as a hydroxyl groups per molecule, for example.

A conventional catalyst such as a tin compound, amine, a platinum compound, etc, is used as the catalyst.

These components may be blended in various ratios. For example, the blend ratio of the organopolysiloxane and the cross linking agent is generally within the range of about 100:0.5 to 100:10 (condensation reaction type silicone rubber) or about 100:3 to 100:100 (addition reaction type silicone rubber).

The silicone rubber may optionally contain various additives, are desired. Examples of the suitable additives include reaction inhibitors, release agent, a mold release accelerator, a fluidization adjuster, and so forth. Specifically, the two-component type room temperature-curable silicone rubber is commercially available, for example, from GE Toshiba Silicone under the trade designations “TSE3503”, “TSE350”, “TSE3504”, “TSE3502”, “XE12-246”, “TSE3508”, “XE12-A4001”, “TSE3562”, “TSE3453”, “TSE3453T”, “TSE3455T”, “TSE3456T”, “TSE3457T” and “TSE3450”. Other two-component type room temperature-curable silicone rubber is commercially available from Toray Dow Corning Silicone under the trade designations “SH9550RTV”, “SH9551RTV”, “SH9552RTV”, “SH9555RTV”, “SH9556RTV” and “SH9557RTV”. In addition to the above products, two-component type room temperature-curable silicone rubbers are also commercially available from Sumitomo 3M Ltd. under the trade designations “6160”, “7322H” and “0425H”. Details concerning two-component type room temperature-curable silicone rubber is described in Kumada and Wada, “Recent Application Technologies of Silicone”, published on Feb. 26, 1987 by Kabushiki Kaisha CMC.

Various polyurethanes are suitable for the transfer pattern layer. Polyurethanes are generally prepared by the reaction of at least hydroxyl containing material with at least one polyisocyanate. “Polyisocyanate” means any organic compound that has two or more reactive isocyanate (—NCO) groups in a single molecule such as diisocyanates, triisocyanates, tetraisocyanates, etc., and mixtures thereof. Cyclic and/or linear polyisocyanate molecules may usefully be employed.

Various suitable polyisocyanates are available from Mitsui-Takeda Chemical, including toluene diisocyanate (TDI) adducts of the “Takenate D100” series (such as D-101A, D-102, D-103, D-103H, D-103M2, D-104)”; TDI polymeric isocyanates of the “Takenate D200” series (such as D-204, D-204EA, D-212, D-212L, D-212M6, D-262, D-215, D-217, D-218, D-219, D-268, D-251D); as well as xylylene diisocyanate (XDI), isophoronediisocyanate (IPDI), hexamethylene diisocyanate (HDI) adducts of the “Takenate D 110 series (D-110N, D-120N, D-127N, D-140N, D-160N, D-165N, D-170N, D-170HN, D-172N, D-177N, D-178N)”.

Although the hydroxyl group-containing material is typically a polyol comprising two or more hydroxyl groups, material comprising a single hydroxyl group may be employed alone or in combination with a polyol. A variety of polyols can be utilized in the preparation of the modified isocyanate component. Suitable polyols include polyester polyols, polyether polyols, polydiene polyols, hydrogenated polydiene polyols, polycarbonate polyols, and hydrocarbon polyols. Although the polyol may contain more than two hydroxyl groups, in at least some embodiments, the polyol is preferably difunctional.

Various polyester polyols are available from Mitsui-Takeda Chemical such as polyester polyols of the “Takelec U” series (such as U-21, U-24, U-25, U-27, U-53, U253, U-502, U-118A); acrylic polyols of the “Takelec UA” series (such as UA-702, UA-902, UA-906); and polyurethane polyols of the “Takelec E” series (such as E-158, E-550, E-551T, E-553, E-900).

The transfer pattern layer formed upon curing of the (e.g. room temperature) curable composition (also called “precursor of the transfer pattern layer”) has sufficient strength and other properties and can be as such used as a shape-imparting molding member of the transfer mold. The curing can be carried out under various conditions. It is preferred however, the composition of the transfer layer cures ambient temperatures, ranging from 25° C. to 100° C. For example, the silicone rubber transfer layer may be cured at 25° C. for about 16 hours or at 100° C. for about 2 hours.

A primer layer may be optionally provided between the transfer layer and the base to improve the adhesion of these layers to each other. Various primer compositions are known in the art suitable for this purpose. In the case of silicone rubber transfer layers, polyalkylsiloxane, polyalkoxysilane, and mixture thereof provide suitable primer layers. In the case of polyurethane, isocyanate or hydroxy functional material provided suitable primers.

The thickness of the transfer pattern layer can vary but is generally at least about 0.005 mm and typically no greater than 10 mm. Preferably the transfer pattern layer is at least about 20 μm and preferably no greater than 200 μm. When the thickness of the transfer pattern layer is smaller than 0,005 mm, it becomes difficult to impart the positive protrusion pattern to the surface of the layer. When the thickness of the transfer pattern layer exceeds 10 mm the material costs increase.

The positive protrusion transfer mold employs a master mold having on its surface a negative groove pattern (recess pattern) having a shape and a size corresponding to those of the fine structure pattern of the fine structure. Therefore, the transfer mold provides also the effect that machining of the master mold can be made easily and within a relatively short time. The grid-like recess pattern of the master mold can be machined into a metal drum. In the case of PDP the master is typically fabricated by machining grooves into a flat planar substrate. The master mold preferably comprises a machinable metal such as brass, copper, aluminum, beryllium-copper alloys, as well as electrolytic and electroless nickel-phosphor alloys. When a fine structure (for example, PDP rib) is directly produced by transfer from a master mold having a recess pattern on its surface as has been made in the prior art, a problem such as breakage of protrusion portions (such as ribs) occurs. In contrast, because the invention uses the transfer mold having a specific structure, the invention can avoid such a problem. In short, the master mold having a grid-like recess pattern can easily be processed and the grid-like ribs can be formed without inviting the rib defects.

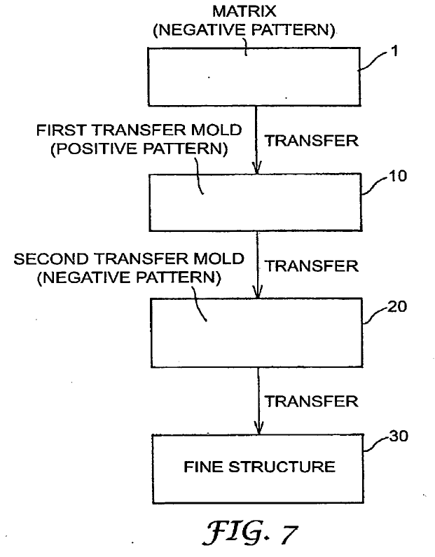

The fine structure, is preferably produced by the following steps (e.g. in sequence) as will be hereinafter explained with reference to FIG. 7:
production of a matrix (master mold) having a grid-like recess pattern;
production of a transfer mold (first transfer mold) having a grid-like protrusion pattern;
production of a mold (second transfer mold), for forming a fine structure, having a grid-like recess pattern; and
production of a fine structure.

Since this production process involves a large number of process steps, there are increased opportunities to introduce dimensional accuracy errors. Because the invention employs the transfer mold having a specific structure as the first transfer mold as described above, however, the invention can easily keep dimensional accuracy. This effect can be further improved by use of a flexible mold to be next explained as the second transfer mold.

The transfer mold according to the invention can be produced by various methods but is preferably produced by the method comprising the following steps:
forming a transfer pattern layer having on its surface a positive pattern (positive protrusion pattern) having a shape and a size corresponding to those of the fine structure pattern of the intended fine structure from a (e.g. two-component room temperature-curable composition (e.g. silicone rubber or polyurethane); and
supporting the back of the transfer pattern layer by use of a base, preferably formed of a hard material having a high elastic modulus.

Further, in the practice of this production method, it is preferred to use a master mold having on its surface a negative groove pattern having a shape and a size corresponding to those of the fine structure pattern of the fine structure as a matrix, to transfer the groove pattern of the master mold and to form the positive protrusion pattern of the transfer pattern layer.

In greater detail, the transfer mold according to the invention can be produced by conducting, in sequence, the following steps:
applying a two-component (e.g. room temperature) curable composition (e.g. silicone rubber or polyurethane) at a predetermined thickness onto a surface of a master mold to thereby form a precursor layer of the transfer pattern layer described above;
stacking the base onto the master mold to thereby form a stacked body including the master mold, the precursor of the transfer pattern layer and the base;
curing the composition; and
releasing the transfer pattern layer formed by curing of the composition, together with the base, from the master mold.

FIG. 5 typically shows a production method of a transfer mold according to the invention.

First, a master mold 1 that is shown by a perspective view in FIG. 6 and by a sectional view taken along a line V(A)-V(A) in FIG. 6 is prepared. The master mold 1 is used as the matrix when the transfer mold 10 according to the invention shown in FIGS. 3 and 4 is produced, and is formed of a flat sheet of brass, for example. The master mold 1 has on its surface a negative groove pattern 4 having a shape and a size corresponding to those of the fine structure pattern of the fine structure. Incidentally, the illustrated example assumes the production of the grid-like PDP rib as the fine structure. Therefore, the negative groove pattern 4 is the grid-like groove pattern as shown in FIG. 6. The negative groove pattern 4 has a more complicated arrangement than a stripe pattern, but can be machined far easier and within a shorter time than when the protrusion pattern is processed on the surface of the mold. The groove pattern can be formed by providing fine grooves on the surface of the mold with use of milling or discharge processing. The shape and the size of the negative groove pattern 4 can be easily understood from the explanation of the PDP rib already explained.

Next, as shown in FIG. 5(B), the (e.g. two-component room temperature) curable composition (e.g. silicone rubber or polyurethane) 2 used as the precursor of the transfer pattern is applied at a predetermined film thickness onto the surface of the master mold 1 so prepared. The illustrated example employs the method that applies the curable composition 2 to the surface of the master mold 1 and (e.g. serially) fills the groove patterns 4. However, other method may also be used. According to another method, the master mold and the base for the transfer mold are arranged with a predetermined gap between them and the curable composition is then charged into the gap. The precursor layer 2 of the transfer pattern layer can be formed at the predetermined thickness by either any of these methods. Alternatively, the curable composition 2 may be processed (e.g. partially cured) into a sheet and is then stacked on the pattern surface of the master mold 1 so as to bring them into contact.

Subsequently, as shown in FIG. 5(C), the base 11 for the transfer mold is put on the master mold 1 and a stacked body including the master mold 1, the precursor layer of the transfer pattern layer and the base 11 is formed. Incidentally, the drawing shows the transfer pattern layer 12 formed by curing of the precursor. In other words, when the precursor is cured, the transfer mold 10 including the base 11 and the transfer pattern layer 12 supported by the base 11 can be obtained. The curable composition is generally curable within a few hours.

Finally, the resulting transfer mold is released from the master mold, though not explained with reference to the drawing. The mold after mold releasing may be cured at a room temperature or at an elevated temperature, whenever necessary.

In another aspect, the invention relates to the production method of the fine structure. This production method may be carried out through any production process steps so long as it uses the transfer mold according to the invention. The production method of the invention can be carried out particularly advantageously through the sequence shown in FIG. 7.

To begin with, the master mold having the negative pattern is prepared as the matrix 1 as described above.

Next, the negative pattern of the matrix 1 is transferred (i.e. in reverse image) in the same way as described above to produce the transfer mold (first transfer mold) 10 having the positive pattern.

The positive pattern of the first transfer mold 10 so produced is transferred (i.e. in reverse image) to produce the mold (second transfer mold) 20 for the fine structure, having the negative pattern. Incidentally, it is advantageous to produce the transfer mold 20 as a flexible mold as will be hereinafter explained. In the practice of the invention, a large number of second transfer molds 20 can be acquired with high accuracy from a single first transfer mold 10.

The production of the fine structure 30 having the positive pattern can be carried out by various methods that involve the transfer (i.e. in reverse image) of the second transfer mold 20.

In one preferred embodiment, the production method of the fine structure according to the invention can be carried out advantageously by conducting, in sequence, the following steps:
applying the curable resin composition at a predetermined film thickness onto the pattern formation surface of the transfer mold and forming the precursor layer of the shape-imparting layer;
stacking further the support formed of the flexible film of the plastic material on the transfer mold and forming the stacked body including the mold, the precursor layer of the shape-imparting layer and the support;
curing the curable resin composition;
releasing the shape-imparting layer, formed by curing of the curable resin composition, together with the support from the transfer mold and producing the flexible mold (second transfer mold) having the support and the shape-imparting layer supported on the back thereof by the support and having on its surface the negative groove pattern having the shape and the size corresponding to those of the fine structure pattern;
applying the curable protrusion-forming material between the substrate and the shape-imparting layer of the flexible mold to introduce the protrusion-forming material into the groove pattern of the mold;
curing the protrusion-forming material and producing the fine structure including the substrate and the protrusion pattern integrally bonded with the substrate; and
removing the fine structure from the flexible mold.

In the production method of the fine structure according to the invention, the shape and construction of the second transfer mold having the negative groove pattern are not particularly limited, but the flexible mold can be advantageously used as described above. The flexible mold generally has a two-layered structure of the support and the shape-imparting layer supported by the support. However, the use of the support may be omitted provided that the shaping imparting layer itself has the function of the support. The flexible mold basically has the two-layered structure but an additional layer or layers or coating may be added, whenever necessary.

The form, the material and the thickness of the support in the flexible mold are not limited so long as it can support the shape-imparting layer and has sufficient flexibility and suitable hardness for securing flexibility of the mold. Generally, however, a flexible film of a plastic material (plastic film) can be advantageously used for the support. The plastic film is preferably transparent, having at least transparency sufficient to transmit the ultraviolet rays irradiated for forming the shape-imparting layer. Both the support and the shape-imparting layer are preferably transparent particularly in view of the fact that the PDP rib and other fine structures are produced from a photo-curable molding material by use of the resulting mold.

To control pitch accuracy of the groove portions of the flexible mold in the plastic film, it is preferred to select the plastic film that is by far harder than the molding material constituting the shape-imparting layer associated with the formation of the groove portions. In one embodiment, a photo-curable material such as a UV-curable composition is employed as the plastic material. Generally, the curing shrinkage ratio of photo-curable materials is a few percent. When the plastic film is hard, dimensional accuracy of the support can be kept even when the photo-curable material undergoes curing shrinkage. Consequently, pitch accuracy of the groove portions can be kept with high accuracy. When the plastic film is hard, pitch fluctuation can be limited to a low level when the rib is formed, and the hard plastic film is advantageously used from the aspects of both moldability and dimensional accuracy. When the plastic film is hard, further, pitch accuracy of the groove portions of the mold depends solely on the dimensional change of the plastic film. Therefore, to stably provide a mold having desired pitch accuracy, it is only necessary to conduct post-treatment so that the size of the plastic film remains as designed but does not appreciably change in the mold after production.

The hardness of the plastic film can be expressed by rigidity to tension, that is, by tensile strength. The tensile strength of the plastic film is generally about 5 kg/mm as reported by the Handbook of Chemistry and Physics, CRC Press. The tensile strength is preferably at least about 10 kg/mm². When the tensile strength of the plastic film is lower than 5 kg/mm², handling property drops when the resulting mold is taken out from the master mold or when the PDP rib is taken out from the resulting mold and breakage and tear are likely to occur.

The plastic film is generally obtained by molding the plastic raw material into a sheet and is commercially available in the cut sheet form or in the roll form wound into the roll. Surface treatment may be applied to the plastic film to improve the adhesion strength of the shape-imparting layer to the plastic film, whenever necessary.

The shape-imparting layer preferably consists of a cured resin preferably formed by curing the UV-curable composition containing the acrylic monomer and/or oligomer as the main component. The method of forming the shape-imparting layer from the UV-curable composition is advantageous because an elongated heating furnace is not necessary for forming the shape-imparting layer and moreover, the cured resin can be obtained by curing the composition within a relatively short time.

Examples of the acrylic monomer suitable for forming the shape-imparting layer include urethane acrylate, polyether acrylate, polyester acrylate, acrylamide, acrylonitrile, acrylic acid and acrylic acid ester, though they are not restrictive. Examples of the acrylic oligomer suitable for forming the shape-imparting layer include urethane acrylate oligomer, polyether acrylate oligomer, polyester acrylate oligomer and epoxy acrylate oligomer, though they are not restrictive. Particularly, acrylate and a urethane acrylate oligomer can provide a flexible and tough cured resin layer after curing, have an extremely high curing rate among the acrylates in general and can contribute to the improvement of productivity of the mold. Furthermore, when these acrylic monomer and oligomer are used, the shape-imparting layer becomes optically transparent. Therefore, the flexible mold having such a shape-imparting layer makes it possible to use a photo-curable molding material when the PDP rib and other fine structures are produced.

The acrylic monomer and oligomer described above may be used individually or in an combination of two or more. A preferred result can be obtained when the acrylic monomer and/or oligomer is a mixture of urethane acrylate oligomer and mono-functional and/or bi-functional acryl monomer. The mixing ratio of the urethane acrylate oligomer and the acryl monomer in such a mixture can be changed in a broad range, but it is preferred to use about 20 to 80 wt-% of the urethane acrylate oligomer on the basis of the sum of the amounts of the oligomer and the monomer. Preferred resins compositions for the shape-imparting layer of the flexible mold are described in PCT patent application US04/26845 filed 8-18-2004; incorporated herein by reference.

The UV-curable composition may contain a photo-polymerization initiator and other additives, whenever necessary. The photo-polymerization initiator includes 2-hydroxy-2-methyl-1-phenylpropane-1-one, for example. The photo-polymerization initiator can be used in various amounts but is generally and preferably used in an amount of about 0.1 to about 10 wt-% on the basis of the sum of the acryl monomer and/or oligomer. When the amount of the photo-polymerization initiator is smaller than 0.1 wt-%, the curing reaction is remarkably retarded or sufficient curing cannot be achieved. When the amount of the photo-polymerization initiator exceeds 10 wt-%, on the contrary, the unreacted photo-polymerization initiator remains even after completion of the curing process and the problems such as yellowing and degradation of the resin, shrinkage of the resin due to evaporation, etc, occur. The curable composition is typically irradiated with a dose of UV light ranging from 200 mJ/cm² to 2000 mJ/cm². An example of other useful additives is an antistatic agent.

The UV-curable composition can be used at a variety of viscosities (Brookfield viscosity; so-called “B” viscosity) in the formation of the shape-imparting layer, but a preferred viscosity is generally within the range of about 10 to 35,000 cps and preferably within the range of about 50 to 10,000 cps. When the viscosity of the UV-curable composition is outside the range described above, problems are likely to occur in the formation of the shape-imparting layer in that film formation becomes difficult, curing does not sufficiently proceed, and so forth.

The shape-imparting layer can be used at a variety of thickness depending on the construction of the mold and the PDP but is generally within the range of about 5 to 1,000 μm, preferably within the range of about 10 to 800 μm and further preferably within the range of about 50 to 700 μm. When the thickness of the shape-imparting layer is smaller than 5 μm, typically rib heights cannot be obtained. When the thickness of the shape-imparting layer exceeds 1,000 μm, stress becomes great due to curing shrinkage of the UV-curable composition, and the problems such as warp of the mold and degradation of dimensional accuracy occur. In the mold according to the invention, it is preferred that the completed mold can be easily released from the master mold with small force even when the depth of the groove pattern corresponding to the rib height, that is, the thickness of the shape-imparting layer, is designed to a great value.

The groove pattern formed on the surface of the shape-imparting layer will be explained. The depth, pitch and width of the groove pattern can be changed in a broad range depending on the pattern of the PDP rib (straight pattern or grid-like pattern) as the object and on the thickness of the shape-imparting layer itself. In the case of the flexible mold for the grid-like PDP formed from the transfer mold shown in FIGS. 3 and 4, the depth of the groove pattern (corresponding to the height of rib) is generally within the range of about 100 to 500 μm and preferably within the range of about 150 to 300 μm. The pitch of the groove pattern may be different between the longitudinal direction and the transverse direction is generally within the range of about 100 to 600 μm and preferably within the range of about 200 to 400 μm. The width of the groove pattern may be different between the upper surface and the lower surface is generally within the range of about 10 to 100 μm and preferably within the range of about 50 to 80 μm.

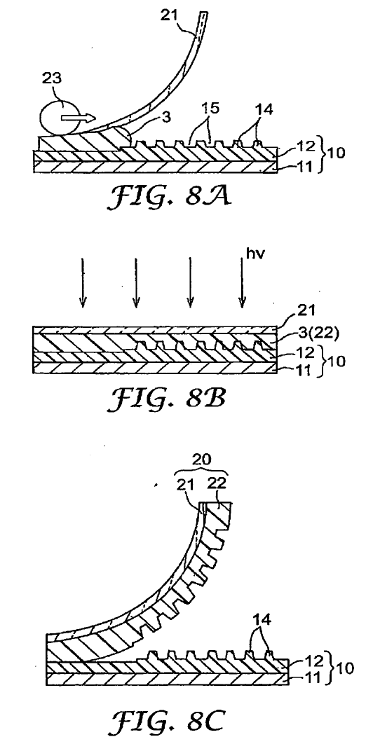

The flexible mold used as the second transfer mold can be produced in accordance with various methods. For example, the flexible mold can be advantageously produced in the sequence serially shown in FIG. 8. Incidentally, the explanation will be made in the drawing about the PDP rib as the example of the fine structure as the production object.

First, as shown in FIG. 8(A), the transfer mold (first transfer mold) 10 having the shape and the size corresponding to those of the PDP rib is produced by the method already explained with reference to FIG. 5. The first transfer mold 10 includes the base 11 and the transfer pattern layer 12 supported by the base 11. The first mold 10 has on its surface partitions 14 having the same pattern and the same shape as those of the PDP back plate. Therefore, the cavities (recesses) 15 defined by the adjacent partitions 14 operate as the discharge display cells of the PDP. A taper for preventing entrapment of bubbles may be formed at the upper end of the partition 14. When the transfer mold having the same form as the final rib form is prepared, the processing of the end portions after the formation of the rib becomes unnecessary and the occurrence of defects due to fragments resulting from the end portion processing can be eliminated. According to this production method, the amount of residues of the molding material on the transfer mold is extremely small because the molding material for forming the shape-imparting layer is completely cured. Consequently, the transfer mold can be re-used easily. A support formed of a transparent plastic film (hereinafter called “support film”) 21 and a laminate roll 23 are prepared with this first transfer mold 10. The laminate roll 23 is for pushing the support film 21 on the transfer mold 10 and is a rubber roll. Other known or customary laminate means may be used in place of the laminate roll, whenever necessary. The support film 21 is the polyester film or other transfer plastic films described above.

Next, a predetermined amount of the UV-curable molding material 3 is applied to the end face of the transfer mold 10 by use of the known or customary coating means (not shown in the drawing) such as a knife coater or a bar coater. A vaccum chamber is preferably sealed to the transfer mold around the patterned area in order to degass the filled mold. The vacuum is then removed and any excess resin is removed with for example a doctor blade.

Next, the laminate roll 23 is contacted with the transfer mold in the direction indicated by an arrow. As a result of this laminate treatment, the molding material 3 can be uniformly distributed to a predetermined thickness, and the gaps of the partitions 14 are filled with the molding material 3.

After the lamination treatment is completed, ultraviolet rays (hν) are irradiated to the molding material 3 through the support film 21 as indicated by arrows in FIG. 8(B) while the support film 21 remains stacked on the transfer mold 10. Here, when the support film 21 is formed uniformly of a transparent material without containing light scattering elements such as bubbles, the irradiated rays of light can uniformly reach the molding material 3 almost without attenuation. As a result, the molding material is effectively cured and is converted to the uniform shape-imparting layer 22 bonded to the support film 21. Incidentally, since ultraviolet rays having a wavelength of 350 to 450 nm, for example, can be used in this step, there is the merit that a light source generating high heat such as a high-pressure mercury lamp typified by a fusion lamp need not be used. Furthermore, because the support film and the shape-imparting layer do not undergo thermal deformation during the irradiation of the ultraviolet rays, there is another merit that high pitch control can be made.

Thereafter, the flexible mold 20 is removed from the transfer mold while keeping its integrity as shown in FIG. 8(C).

The flexible mold is useful for producing various fine structures. For example, the flexible mold is useful for molding a PDP rib having a straight rib pattern or a grid-like rib pattern. When this flexible mold is used, a large screen size PDP having a rib structure in which ultraviolet rays do not leak easily from a discharge display cell to outside can be easily produced by merely using the laminate roll in place of vacuum equipment and/or a complicated process.

The flexible mold is particularly useful for producing the grid-like PDP rib in which a plurality of ribs are arranged substantially parallel to one another while intersecting one another with predetermined gaps among them. Such a flexible mold can be easily released from the transfer mold without inviting the problems such as deformation and breakage, though it is a mold for producing ribs having large sizes and complicated shapes.

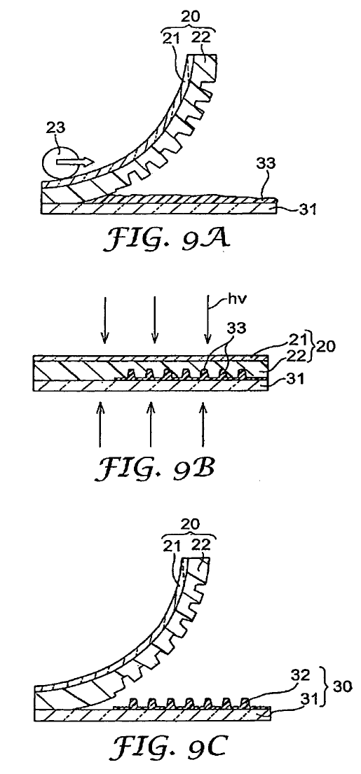

The PDP ribs can be advantageously produced by use of the flexible mold produced by the method described above or by other methods. Hereinafter, a method of producing a PDP rib having a grid-like rib pattern by use of the flexible mold 20 produced by the method shown in FIG. 8 will be serially explained with reference to FIG. 9. Incidentally, a production method shown in FIGS. 1 to 3 of Japanese Unexamined Patent Publication (Kokai) No. 2001-191345, for example, can be used advantageously.

First, a glass flat sheet having on its upper surface stripe-like electrodes arranged in a predetermined pattern is prepared, though it is not shown in the drawing. Next, the flexible mold 20 having a groove pattern on the surface thereof is placed at a predetermined position on the glass flat sheet 31 as shown in FIG. 9(A), and the glass flat sheet 31 and the mold 20 are positioned (aligned). Here, the glass flat sheet 31 has the address electrodes and the dielectric layer as shown in FIG. 2 but they are omitted for simplifying the explanation. Since the mold 20 is transparent, positioning with the electrodes on the glass flat sheet 31 can be easily made. The explanation will be given in further detail. This positioning may be made with eye or by use of a sensor such as a CCD camera. The temperature and the moisture are adjusted at this time, whenever necessary, so as to bring the groove portions of the mold 20 into conformity with the gaps between the adjacent electrodes. For, the mold 20 and the glass flat sheet 31 generally undergo different rates of expansion and contraction due to temperature and moisture. Therefore, after positioning of the glass flat sheet 31 and the mold 20 is completed, control is so made as to keep the temperature and the moisture at that time constant. Such a control method is particularly effective for producing a PDP substrate having a large area.

Subsequently, the laminate roll 23 is put on one of the ends of the mold 20. The laminate roll 23 is preferably a rubber roll. One of the ends of the mold 20 is preferably fixed onto the glass flat sheet 31 at this time because the positioning error between the glass flat sheet 31 and the mold 20 positioning of which has previously been completed can be prevented.

Next, the other free end of the mold 20 is lifted up by a holder (not shown) and is moved above the laminate roll 23 to expose the glass flat sheet 31. Caution is paid at this time lest tension is applied to the mold 20. This is for preventing the occurrence of crease in the mold 20 and for keeping positioning between the mold 20 and the glass flat sheet 31. However, other means may be employed so long as positioning can be kept. Incidentally, because the mold 20 has flexibility in the production method of the invention, the mold 20 can correctly return to its original position during subsequent lamination even when the mold 20 is turned up as shown in the drawing.

Subsequently, a rib precursor 33 is supplied onto the glass flat sheet 31 in an amount necessary for forming the ribs. To supply the rib precursor, a paste hopper equipped with a nozzle can be used, for example.

Here, the term “rib precursor” means an arbitrary molding material capable of forming finally the intended rib molding and is not particularly limited so long as it can form the rib molding. The rib precursor may be either of a thermosetting type or a photo-curing type. The photo-curable rib precursor, in particular, is extremely effective when used in combination with the transparent flexible mold described above. As also described above, the flexible mold does not involve defects such as deformation and can suppress non-uniform scatter of light, and so forth. In consequence, the molding material is uniformly cured to provide ribs having constant and excellent quality.

An example of a composition suitable for the rib precursor is a composition which basically contains (1) a ceramic component for imparting a rib shape such as aluminum oxide, (2) a glass component for filling the gaps of the ceramic component and imparting compactness to the rib such as lead glass and phosphate glass and (3) a binder component for accommodating, holding and bonding mutually the ceramic component and its curing agent or polymerization initiator. Curing of the binder component does not rely on heating or wetting but preferably on irradiation of light. In such a case, thermal deformation of the glass flat sheet need not be taken into consideration.

In the practice of the illustrated production method, the rib precursor 33 is supplied to the entire surface of the glass flat sheet 31. The precursor 33 generally has a viscosity of about 20,000 cps or below and preferably about 5,000 cps or below. When the viscosity of the rib precursor is higher than about 20,000 cps, the laminate roll cannot sufficiently spread the rib precursor, so that air is entrapped into the groove portions of the mold and is likely to invite the rib defects. As a matter of fact, when the viscosity of the rib precursor is below about 20,000 cps, the rib precursor can be uniformly spread between the glass flat sheet and the mold and can uniformly fill all the groove portions without containing bubbles when the laminate roll is moved only once from one of the ends of the glass flat sheet to the other.

Next, a motor (not shown) is driven to move the laminate roll 23 on the mold 20 at a predetermined speed as indicated by an arrow in FIG. 9(A). While the laminate roll 23 thus moves on the mold 20, the pressure is applied to the mold 20 from one of the ends thereof to the other by the weight of the laminate roll 23. Consequently, the rib precursor 33 is spread between the glass flat sheet 31 and the mold 20 and fills also the groove portions of the mold 20. In other words, the rib precursor 33 serially replaces air in the groove portions and fills them. The thickness of the rib precursor can be set at this time to the range of a few microns (μm) to dozens of microns (μm) by suitably controlling the viscosity of the rib precursor or the diameter, weight or moving speed of the laminate roll.

According to the illustrated production method, even when the groove portions of the mold operate also as the air channel and store air, air can be efficiently discharged outside or to the periphery of the mold when the pressure is applied thereto as described above. As a result, this production method can prevent the bubbles from remaining even when filling of the rib precursor is carried out at the atmospheric pressure. In other words, pressure reduction need not be made to fill the rib precursor. Needless to say, the bubbles can be removed more easily when the pressure is reduced.

The rib precursor is subsequently cured. When the rib precursor 33 spread on the glass flat sheet is of the photo-curable type, the stacked body of the glass flat sheet 31 and the mold 20 is put into a light irradiation apparatus (not shown) as shown in FIG. 9(B), and the ultraviolet rays or the like are irradiated to the rib precursor 33 through the glass flat sheet 31 and through the mold 20 to cure the rib precursor 33. In this way is obtained a molding of the rib precursor, that is, the rib itself.

Finally, while the resulting rib 32 remains bonded to the glass flat sheet 31, the glass flat sheet 31 and the mold 20 are taken out from the light irradiation apparatus and the mold is peeled and removed as shown in FIG. 9(C). Since the flexible mold 20 used hereby has excellent handling property, too, the mold 20 can be easily peeled and removed with limited force without breaking the rib 32 bonded to the glass flat sheet 31. A large scale apparatus is not necessary for this peeling and removing work.

Finally, the barrier ribs are fused or sintered by firing such as at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate. However, in applications such as PDP substrates, highly precise and uniform barrier ribs are desirable.

Subsequently, the invention will be explained with reference to examples thereof. Needless to say, the invention is not limited to the examples.

### EXAMPLES

### Example 1

Production of Master Mold

To produce a PDP back plate having ribs (partitions) of a grid-like pattern, a master mold to be used as a matrix was produced. The master mold produced in this example was a mold having on its surface a grid-like groove pattern constituted by a large number of fine grooves arranged substantially parallel while intersecting one another with predetermined gaps among them as explained previously with reference to FIG. 6.

A brass sheet having a length of 400 mm, a width of 700 mm and a thickness of 5 mm was prepared and 1,845 longitudinal grooves (corresponding to longitudinal ribs) and 608 transverse grooves (corresponding to transverse ribs) were cut and formed on one of the surfaces of the brass sheet as shown in FIG. 6. The longitudinal grooves had a pitch of about 300 μm (distance between centers of adjacent longitudinal grooves), a depth (corresponding to rib height) of about 210 μm, a groove bottom width (corresponding to rib top width) of about 200 μm and a groove top width (corresponding to rib bottom width) of about 200 μm. The transverse grooves had a pitch of about 510 μm (distance between centers of adjacent transverse grooves), a depth (corresponding to rib height) of about 210 μm, a groove bottom width (corresponding to rib top width) of about 40 μm and a groove top width (corresponding to rib bottom width) of about 200 μm. As to the master mold so produced, the total pitch (distance between centers of ribs at both ends) was measured at five positions for each of the longitudinal groove corresponding to the longitudinal rib and the transverse groove corresponding to the transverse rib and the result tabulated in the following Table 1 was obtained.

Production of (First) Transfer Mold Comprising a Silicone Rubber Transfer Layer

The first transfer mold was produced by use of the master mold obtained as described above in accordance with the method previously explained with reference to FIG. 5. The perspective view of this transfer mold is shown in FIG. 3 and its sectional view taken along a line IV-IV is shown in FIG. 4.

A stainless steel sheet having a length of 400 mm, a width of 700 mm and a thickness of 1 mm was prepared as a base of the transfer mold. A primer treatment (polyalkylsiloxane and tetraethoxysilane commercially available from GE Toshiba Silicone Co. under the trade designation “ME121”) was applied to a transfer pattern formation surface of the stainless steel sheet to improve adhesion between the stainless steel sheet and the transfer pattern layer (silicone rubber layer). After the primer was applied for the primer treatment, it was dried at 150° C. in the course of one hour.

The groove pattern surface of the master mold produced in the previous step was so arranged as to face the primer treatment surface of the base and a two-component type room temperature-curable silicone rubber (commercially available from GE Toshiba Silicone Co. under the trade designation “XE12-A4001”) was filled into a gap (of about 100 μm) between them and was left standing for 12 hours for curing. The resulting silicone rubber transfer mold had a grid-like protrusion pattern as shown in FIGS. 3 and 4 and the shape and the size of the protrusion portion corresponded to those of the grid-like groove pattern of the master mold, respectively. In other words, the protrusion portion of the resulting transfer mold had the longitudinal protrusion portion and the transverse protrusion portion each having an isosceles trapezoidal section and arranged substantially parallel to one another while intersecting one another with predetermined gaps among them. Each protrusion portion had a height of 210 μm (for both longitudinal and transverse protrusion portions), a top width of 110 μm and a bottom width of 200 μm for the longitudinal protrusion portion, a top width of 40 μm and a bottom width of 200 μm for the transverse protrusion portion, and a pitch (distance between centers of adjacent longitudinal protrusion portions) of 300 μm for the longitudinal protrusion portion and a pitch of 510 μm for the transverse protrusion portion. When the total pitch (distance between protrusion portions at both ends) of the silicone rubber transfer mold so produced was measured at five positions for the longitudinal protrusion portion corresponding to the longitudinal rib and the transverse protrusion portion corresponding to the transverse rib, respectively, the measurement result tabulated in the following Table 1 was obtained. Furthermore, the condition of the protrusion portions of the resulting transfer mold was examined through an optical microscope, defects were not at all observed in the fine protrusion portions.

TABLE 1

| | point of | | silicone rubber-made |
|---|---|---|---|
| | measurement | master mold | transfer mold |
| total pitch | 1 | 553.190 | 553.189 |
| (longitudinal | 2 | 553.190 | 553.186 |
| rib, mm) | 3 | 553.186 | 553.185 |
| | 4 | 553.188 | 553.183 |
| | 5 | 553.184 | 553.191 |
| total pitch | 6 | 309.564 | 309.565 |
| (transverse | 7 | 309.559 | 309.560 |
| rib, mm) | 8 | 309.556 | 309.557 |
| | 9 | 309.554 | 309.553 |
| | 10 | 309.561 | 309.565 |

As could be understood from the measurement result shown in Table 1, when producing the transfer mold for the PDP rib, dimensional accuracy of the master mold could be transferred extremely accurately to the silicone rubber transfer mold when the master mold having the negative groove pattern on its surface was used as stipulated in the invention, and the transfer pattern layer was formed by molding the silicone rubber on the base formed of the hard material having a high elastic modulus.

Production of Flexible Mold (Second Transfer Mold)

A flexible mold (second transfer mold) was produced by use of the first transfer mold produced as described above and by the method explained previously.

To form the shape-imparting layer of the mold, two kinds of UV-curable resin compositions containing the following components were prepared.

High Viscosity UV-Curable Resin Composition (A):

80 wt-% aliphatic urethane acrylate oligomer (“Photomer 6010”)
20 wt-% 1,6-hexanediol diacrylate
1 wt-% 2-hydroxy-2-methyl-1-phenyl-propane-1-on photo-polymerization photoinitiator,
(“Darocure 1173”)
   Low Viscosity UV-Curable Resin Composition (B):
40 wt-% aliphatic urethane acrylate oligomer (“Photomer 6010”)
60 wt-% 1,6-hexanediol diacrylate
1 wt-% photoinitiator (“Darocure 1173”)

When the viscosity of each resin composition was measured by use of a Brookfield (B) viscometer, it was 8,500 cps for the resin composition (A) and 110 cps for the resin composition (B) (spindle #5, 20 rpm, 22° C.).

A PET film, commercially available from Teijin Co. under the trade designation “HPE188”, having a length of 700 mm, a width of 700 mm and a thickness of 188 μm was prepared as the support of the mold.

Next, the UV-curable resin composition (A) prepared as described above was applied to a thickness of about 200 μm to one of the surfaces of the PET film. On the other hand, the UV-curable resin composition (B) was applied to the transfer pattern surface of the transfer mold produced was poured over the transfer pattern surface of the transfer mold and then spread by use of a blade. Thereafter, the PET film and the transfer mold were put one upon another so that respective resin coatings faced each other. The longitudinal direction of the PET film was set to be parallel to the longitudinal protrusion portions of the transfer mold, and the total thickness of the UV-curable resin composition sandwiched between the PET film and the transfer mold was set to about 250 μm. When the PET film was carefully pushed by use of a laminate roll, the UV-curable resin composition was completely filled into the recesses of the transfer mold and entrapment of bubbles was not observed.

Under this state, ultraviolet rays having a wavelength of 300 to 400 nm (peak wavelength: 325 nm) were irradiated for 30 seconds to the UV-curable resin composition through the PET film by use of a fluorescent lamp, a product of Mitsubishi Denki-Oslam Co. The irradiation dose of the ultraviolet rays was from 200 to 300 mJ/cm². The shape-imparting layer could be obtained when each of the two kinds of UV-curable resin compositions was cured. Subsequently, when the PET film was peeled with the shape-imparting layer from the transfer mold, there was obtained a flexible mold equipped with a grid-like groove pattern having a shape and a size corresponding to those of the grid-like protrusion pattern of the transfer mold.

Production of PDP Back Plate

A PDP plate (fine structure according to the invention) was produced by use of the flexible mold produced as described above and by the method explained previously with reference to FIG. 9.

The flexible mold was positioned to and arranged on the PDP back plate. The groove pattern of the mold was so arranged as to face the glass substrate. Next, a photosensitive ceramic paste was filled to a thickness of 110 μm between the mold and the glass substrate. The ceramic paste hereby used had the following composition.
Photo-curable oligomer: 21.0 g bis-phenol A diglycidyl methacrylate acid adduct commercially available from Kyoei-sha Kagaku K. K. under the trade designation “3000M”
Photo-curable monomer: 9.0 g triethyleneglycol dimethacryate commercially available from Wako Jyunyaku Kogyo K. K.
Diluent: 30.0 g 1,3-butanediol commercially available from Wako Junyaku Kogyo K. K.
Photo-polymerization initiator: 0.3 g bis(2,4,6-trimethylbenzoyl)-phenylphosphine oxide commercially available from Ciba Specialty Chemicals Co. under the trade designation “Irgacure 819”
Surfactant: 1.5 g phosphate propoxyalkylpolyol obtained from 3M Company
Sulfonic acid type surfactant: 1.5 g commercially available from Kao K. K. under the trade designation “NeoPelex #25”
Inorganic particles: 270.0 g Mixed powder of lead glass and ceramic commercially available from Asahi Glass K. K. under the trade designation “RFW-030”

When the viscosity of this ceramic paste was measured by use of the Brookfield (B) viscometer, it was 7,300 cps (spindle #5, 20 rpm, 22° C.).

After the ceramic paste was applied to the entire surface of the glass substrate, the mold was laminated in such a fashion as to cover the surface of the glass substrate. The mold was carefully pushed by use of a rubber laminate roll having a diameter of 200 mm and a weight of 30 kg and the ceramic paste was completely filled into the groove portions of the mold.

Under this state, blue light having a wavelength of 400 to 500 nm (peak wavelength: 450 nm) was irradiated from both surfaces of the mold and the glass substrate by use of a fluorescent lamp of Phillips Co. The irradiation dose of UV light was from 200 to 300 mJ/cm². The ceramic paste was cured to give the rib. Subsequently, when the glass substrate was peeled with the rib on the glass substrate from the mold, there was obtained the glass substrate having the grid-like ribs. In the resulting glass substrate, the shape and the size of the rib was correctly coincident with those of the groove portions of the master mold used for producing the transfer mold. Finally, the glass substrate was baked at 550° C. for 1 hour to bum and remove organic components in the paste. The PDP back plate having the grid-like ribs consisting only of the glass components was thus obtained. When any defects of the rib were examined through an optical microscope, no defect could be observed.

### Example 2

A primer (“ME121”) was coated on a 100 cm×100 cm×1 mm thick stainless steel plate (Japanese Inductrial Standard SUS430), followed by 30 min. drying in an ambient condition then heat treatment at 150° C. and for 1 hour.

A room temperature curable silicone rubber (“XE 12-A4001”) is put between the heat treated stainless steel substrate and a metal master tool having lattice grooves on the surface and conditioned for 12 hours. Then the stainless steel substrate with the silicone rubber was detached from the metal master tool producing a first transfer mold was obtained.

A mixture of aliphatic urethane acrylate oligomer, commercially available from Daicel UCB under the trade designation “Ebecryl 270” and 1% photoinitiator (“Darocure 1173”) is put between a polyethylene terephthalate film, commercially available from Teijin Co. under the trade designation “Tetron Film”, and the first transfer mold, followed by 300-400 nm UV radiation by use of fluorescence lamp (made by Mitsubishi-Osram) for 30 seconds. Then the plastic film with cured resin was detached from the first transfer mold to obtain a second transfer mold.

Ten second transfer molds were made from the one first transfer mold. All ten molds were observed carefully and found not to have defects caused by delamination of the first transfer mold. The first transfer mold was also observed no to exhibit any delamination.

### Example 3

Production of (First) Transfer Mold Comprising a Polyurethane Transfer Layer

Fluorine-type release agent (commercially available from Daikin Industries Ltd. under the trade designation “DAIFREE GA-6010”) was sprayed on the surface of the master tool to avoid adhesion between the master tool and polyurethane.

Stainless steel plate 1 mm in thickness was prepared for use as the base substrate. A primer including isocyanate compound (commercially available from 3M Company under the trade designation “N200”) was applied on the steel plate and dried at 100 deg C. for 1 h to enhance the adhesion between polyurethane and the steel plate.

200 g of polyester polyol (“Takelec U-118A”) and 240 g of isocyanate (Takenate D-103) were mixed, vacuumed for de-air, filled between the master tool and the steel plate, and was cured at room temperature to become polyester-type polyurethane. The structured polyurethane was released from the master tool together with the substrate to obtain the lattice pattern first transfer mold. The total pitch data is summarized in Table 1. The total pitch in the first transfer mold is the same as that in the master tool, which indicated that the dimensional accuracy is maintained in the process of transferring from the master tool to the first transfer mold.

The durability of the first transfer mold was investigated by making a second transfer mold from this first transfer mold repeatedly. The formulation of the acrylate resin is described as follows: 45 wt % of aliphatic diacrylate oligomer (Daicel UCB), 45 wt % of 2-ethyl-hexyl diglycol acrylate, 9 wt % of 2-butyl 2 ethyl 1,3-propanediol diacrylate, and 1 wt % of Darocure 1173. The Tg of the polymerized resin was −40° C.

The acrylate was filled between the first transfer mold and the PET film, cured by exposure of 300-400 nm wavelength light for 30 sec released together with the PET film from the first transfer mold to obtain a flexible plastic mold (i.e. second transfer mold). The mold making procedure was repeated at 40 times. The distortion of the patterned polyurethane was investigated by measuring a groove bottom width of the mold that corresponds to the pattern top width of the first transfer mold. As described in Table 2, no change in the groove bottom width was observed. In addition, the urethane first transfer mold itself shows no pattern distortion after 40 times usage. This experiment indicates that the polyurethane first transfer mold exhibits a high durability.

1. A transfer mold comprising:
a transfer pattern layer having a positive protrusion pattern surface comprised of a polymeric material, supported by a base layer comprised of a different material than the transfer pattern layer.

2. The transfer mold of claim 1 wherein the base comprises a material having a Young's modulus ranging from 1 GPa to 250 GPa.

3. The transfer mold of claim 1 wherein the base comprises a material having a Young's modulus ranging from 100 GPa to 250 GPa.

4. The transfer mold of claim 1 wherein the base is a metal material selected from the group consisting of stainless steel, copper and alloys thereof.

5. The transfer mold of claim 1 wherein the transfer pattern layer has a thickness ranging from 0.005 mm to 10 mm.

6. The transfer mold of claim 1 wherein the thickness of the base ranges from 0.1 mm to 5 mm.

7. The transfer mold of claim 1 wherein the protrusion pattern of the transfer pattern layer comprises a plurality of ribs arranged substantially parallel to each other.

8. The transfer mold of claim 1 wherein the protrusion pattern surface of the transfer pattern layer is a grid-like pattern.

9. The transfer mold of claim 1 wherein the positive protrusion pattern corresponds to a barrier rib pattern suitable for a plasma display panel

10. The transfer mold of claim 1 wherein the transfer pattern layer comprises a composition curable at ambient temperature.

11. The transfer mold of claim 1 wherein the transfer pattern layer comprises a cured composition selected from the group consisting of silicone rubber and polyurethane.

12. The transfer mold of claim 11, wherein the polyurethane is a polyester polyurethane.

13. The transfer mold of claim 1 wherein a primer layer is disposed between the base layer and the transfer pattern layer.

14. The transfer mold of claim 13 wherein the transfer pattern layer comprises of silicone rubber and the primer layer is selected from the group consisting of polyalkylsilane, polyalkylsiloxane, and mixture thereof.

15. The transfer mold of claim 13 wherein the transfer pattern layer comprises polyurethane and the primer layer is selected from the group consisting of isocyanate and hydroxyl functional materials.

16. A method of producing a transfer mold comprising the steps of:
providing a base substrate;
forming a transfer pattern layer having a positive protrusion pattern from a curable polymeric composition wherein the curable composition comprises a different material than the base substrate; and
curing the transfer pattern layer.

17. The method of claim 16 wherein the transfer pattern layer is cured at ambient temperature.

18. The method of claim 11 wherein the transfer pattern layer is formed from a master mold having on a surface thereof a negative groove pattern.

19. The method of claim 18 wherein the transfer layer is formed by applying the curable composition onto the negative groove pattern surface of the master mold and stacking the base substrate onto the master mold.

20. A method of producing a negative groove pattern transfer mold comprising;
providing the transfer mold of claim 1;
applying a curable composition onto the transfer pattern layer of the transfer mold;
stacking a support comprising a flexible film of a plastic material on the transfer mold curing the curable resin composition;
releasing the cured resin composition together with the support shape from the transfer mold, thereby forming a flexible mold comprising a support and a shape-imparting layer having a negative groove pattern.

21. The method of claim 20, wherein the curable resin comprises a photocurable resin composition.

22. The method of claim 21 wherein the photo-curable resin composition comprises a UV-curable composition comprising at least one curable component selected from the group consisting of acryl monomer and acryl oligomer.

23. The method of claim 20 wherein the support is transparent.

24. A method of producing a fine structure comprising the steps of:
providing the flexible mold of claim 20;
providing a curable molding material between a substrate and the shape-imparting layer;
curing the molding material, thereby producing a fine structure including the substrate and a protrusion pattern integrally bonded to the substrate; and
releasing the fine structure from the flexible mold.

25. The method of claim 24 wherein the curable molding material is photocurable.

26. The method of claim 24 wherein the protrusion pattern of the fine structure is a rib of a back plate of a plasma display panel.
